(19) United States
(12) Patent Application Publication
(10) Pub. No.: US 2020/0219179 A1
(43) Pub. Date: Jul. 9, 2020

(54) VEHICLE RENTAL MANAGEMENT APPARATUS

(71) Applicant: Honda Motor Co., Ltd., Tokyo (JP)

(72) Inventors: Makiko Matsumoto, Tokyo (JP); Hiroki Yokoyama, Tokyo (JP); Satoru Okubo, Tokyo (JP); Koki Fujisawa, Tokyo (JP); Takuro Masuda, Tokyo (JP)

(21) Appl. No.: 16/735,149

(22) Filed: Jan. 6, 2020

(30) Foreign Application Priority Data
Jan. 9, 2019 (JP) 2019-002222

(51) Int. Cl. G06Q 30/06; G06Q 30/02

(52) U.S. Cl. CPC G06Q 30/0645; G06Q 30/0283

(57) ABSTRACT

A vehicle rental management apparatus configured to incorporate an unused parking space as a station of a vehicle used in a vehicle rental service to manage rental of the vehicle, includes an electronic control unit having a microprocessor and a memory connected to the microprocessor. The microprocessor is configured to perform managing a reservation data of a user of the vehicle; and determining whether use of the vehicle by a station manager managing the station is possible. The determining further includes permitting use of the vehicle by the station manager within a reservable time period during which the vehicle is not reserved by the user when the reservable time period of a predetermined length is found from the vehicle reservation data managed in the managing.

### CROSS-REFERENCE TO RELATED APPLICATION

This application is based upon and claims the benefit of priority from Japanese Patent Application No. 2019-002222 filed on Jan. 9, 2019, the content of which is incorporated herein by reference.

### BACKGROUND OF THE INVENTION

### Field of the Invention

This invention relates to a vehicle rental management apparatus for vehicle rental management.

### Description of the Related Art

People who live in detached (stand-alone) residential houses or similar have long generally parked their cars (privately owned vehicles) in a residential parking space on the house property. Recently, however, such detached residential house parking spaces have increasingly fallen into disuse because many stand-alone house owners are parting with their cars because they growing old or because car rental services have become more attractive. Against this backdrop, apparatuses (systems) have emerged that, by installing a generic signboard and communication means in an idle parking space, make the parking space usable as a pay-by-hour parking space. A conventional apparatus of this type is disclosed in, for example, JP-2015-057679A.

In the case of the apparatus taught by JP-2015-057679A, however, the house owner can receive income only when the idle parking space is being used as a pay-by-the-hour parking space, so that the apparatus cannot take full advantage of the idle parking space. Moreover, as regards the aforesaid car rental service, stations are hard to secure at highly convenient locations in residential and similar areas.

### SUMMARY OF THE INVENTION

An aspect of the present invention is a vehicle rental management apparatus configured to incorporate an unused parking space as a station of a vehicle used in a vehicle rental service to manage rental of the vehicle, the vehicle rental management apparatus includes an electronic control unit having a microprocessor and a memory connected to the microprocessor. The microprocessor is configured to perform managing a reservation data of a user of the vehicle, and determining whether use of the vehicle by a station manager managing the station is possible. The determining includes permitting use of the vehicle by the station manager within a reservable time period during which the vehicle is not reserved by the user when the reservable time period of a predetermined length is found from the vehicle reservation data managed in the managing.

Another aspect of the present invention is a vehicle rental management method configured to incorporate an unused parking space as a station of a vehicle used in a vehicle rental service to manage rental of the vehicle. The vehicle rental management method includes managing a reservation data of a user of the vehicle; and determining whether use of the vehicle by a station manager managing the station is possible, wherein the determining further includes permitting use of the vehicle by the station manager within a reservable time period during which the vehicle is not reserved by the user when the reservable time period of a predetermined length is found from the vehicle reservation data managed in the managing.

### BRIEF DESCRIPTION OF THE DRAWINGS

The objects, features, and advantages of the present invention will become clearer from the following description of embodiments in relation to the attached drawings, in which:

FIG. 1 is a configuration overview diagram of a vehicle rental management system incorporating a vehicle rental management apparatus according to an embodiment of the present invention;

FIG. 2 is a block diagram showing overall configuration of a vehicle rental management system incorporating the vehicle rental management apparatus according to the embodiment of the present invention;

FIG. 3 is a block diagram showing main configuration of a server unit of FIG. 2;

FIG. 4A is a diagram showing an example of a vehicle reservation data;

FIG. 4B is a diagram showing another example of the vehicle reservation data;

FIG. 5 is a diagram showing an example of relation between incentive calculated by the incentive calculating unit of the server unit of FIG. 2 and vehicle monthly use time; and

FIG. 6 is a flowchart showing an example of processing regarding permission to vehicle use by a station manager, performed by an arithmetic unit of the server unit of FIG. 2.

### DETAILED DESCRIPTION OF THE INVENTION

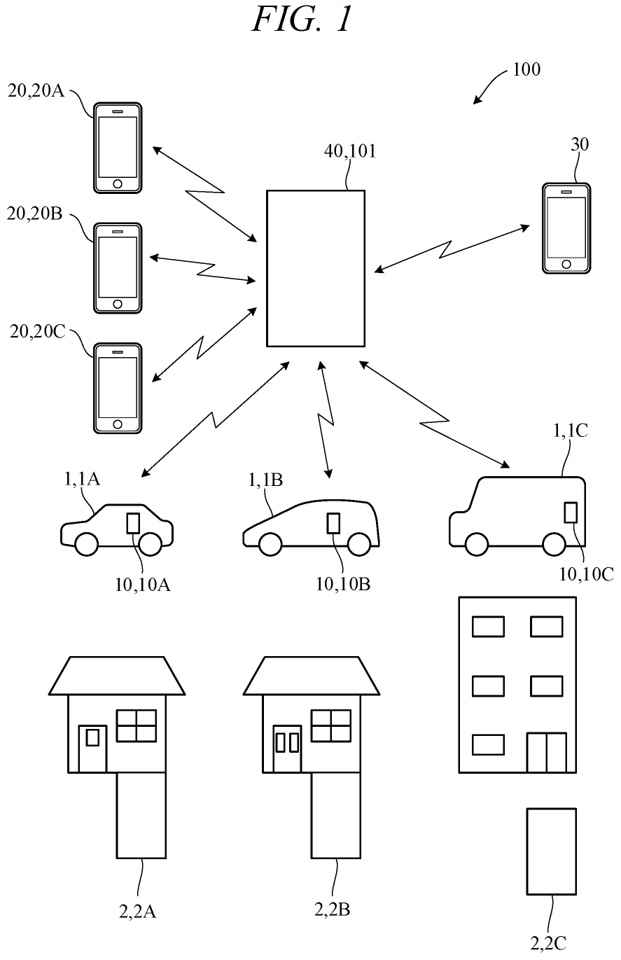

An embodiment of the present invention is explained with reference to FIGS. 1 to 6 in the following. A vehicle rental management apparatus according to an embodiment of the present invention is, for example, adapted to enable a business entity engaged in a vehicle rental service such as the car sharing business to use unused parking spaces (idle parking spaces) associated with residential houses as a vehicle (shared vehicle) stations usable by multiple customer users (hereinafter sometimes called simply “users”). The vehicle rental management apparatus provides a service adapted to allow a station manager in charge of an idle parking space serving as a station to use the shared vehicle parked at the station on certain conditions being met. In other words, the vehicle rental management apparatus of the present embodiment is adapted both to achieve effective use of idle parking spaces and to enhance convenience of vehicle rental service.

Business entities providing vehicle rental services include car-sharing businesses and rental car businesses. The practice in the car-sharing business is, for example, for a user (customer) to rent a car (shared vehicle) using a pre-registered IC card or similar without aid of a station attendant and for the user to be charged at vehicle return in accordance with time used and/or distance driven. The rental car business differs from the car-sharing business in the point that car (shared vehicle) rentals are concluded between renters and station attendants. Although the vehicle rental management apparatus according to the present embodiment can also be utilized by a business entity engaged in the rental car business, it is explained in the following taking use by an entity engaged in the car-sharing business as an example.

FIG. 1 is a configuration overview diagram of a vehicle rental management system 100 incorporating a vehicle rental management apparatus 101 according to an embodiment of the present invention. As shown regarding the vehicle rental management system 100 in FIG. 1, a business entity engaged in car-sharing business maintains a number of vehicles 1 (e.g., vehicles 1A, 1B and 1C) put to use in its car-sharing business, and idle parking spaces at detached residential houses, multifamily residential buildings and/or other residential locations are used as stations 2 (e.g., stations 2A, 2B and 2C) of these vehicles 1 (1A, 1B and 1C). The individual vehicles 1 are equipped with onboard terminals 10 (e.g., onboard terminals 10a, 10b and 10c) that are adapted to communicate with a server unit 40.

The vehicles 1 include various types of four-wheel vehicles of various builds (body size, luggage compartment capacity etc.), such as sedans, minivans, vans, station wagons, trucks and so on. Vehicles 1 used in the car-sharing business can optionally be car-sharing business dedicated models. Making various types of vehicles available gives users a wide range of choices and improves car-sharing convenience. In FIG. 1, the vehicle 1A is a sedan, vehicle 1B is a station wagon, and vehicle 1C is a van.

The stations 2 are pick-up and return locations of vehicles 1 used in the car-sharing business. When a customer uses a vehicle 1, the pick-up location and return location of the vehicle 1 are typically the same station 2. In FIG. 1, the station 2A is the pick-up location and return location of the vehicle 1A, the station 2B is the pick-up location and return location of the vehicle 1B, and the station 2C is the pick-up location and return location of the vehicle 1C.

The stations 2 are idle parking spaces at detached residential houses, multifamily residential buildings and/or other residential locations. By “idle parking space” is meant, for example, a private vehicle parking space that was previously used as a parking space for a privately owned vehicle (e.g., a residential parking space) but that fell into disuse because the vehicle owner parted with the vehicle. In FIG. 1, the stations 2A and 2B are idle parking spaces at detached residential houses and the station 2C is an idle parking space at a multifamily residential building. Optionally, a station manager can rent a parking space on monthly or other fixed term basis at a place favorable from the manager's viewpoint and adopt the rented parking space as an idle parking space for use as a station 2 for a vehicle 1.

The station managers who manage the stations 2 are not limited to owners of idle parking spaces used as stations and can also include managers who do not own but only manage idle parking spaces. When the vehicle 1 parked in the station 2 managed by a certain station manager is not in use, the station manager may, for example, use the vehicle 1 concerned during a period when the vehicle 1 of the station 2 the manager is in charge of is not reserved. The station managers have station manager terminals 20 adapted to communicate with the server unit 40 (e.g., 20A, 20B and 20C) and can use the station manager terminals 20 to output vehicle 1 use requests.

Car-sharing service user (customer) data are recorded in advance at the business entity running the car-sharing business. These data are recorded using user terminals 30 adapted to communicate with the server unit 40. Since the stations 2 are privately owned, user reliability (discussed later) is considered before the user begins to use the vehicle 1 of a station 2 managed by a station manager.

A point of interest in this regard is that a business entity engaged in the car-sharing business itself needs to secure stations for deploying vehicles at various locations by, for example, partially renting coin-pay parking spaces and/or shopping center and convenience store parking lots. In fact, however, such stations are hard to secure, and particularly hard to secure at convenient locations near stations and in dense residential areas because at such convenient locations, the number of parking lot supply is less than the number of parking lots demand. On the other hand, areas marked by stand-alone and multifamily housing are seeing an increase in idle parking spaces as more car owners part with their cars as their children grow up and leave home and they themselves grow older.

In the present embodiment, therefore, parking spaces that have fallen into disuse because of declining car ownership are used as stations of vehicles owned by a business entity engaged in the car-sharing business. As this makes it easier to secure stations at convenient locations, it helps to upgrade convenience of car-sharing service. Station managers of idle parking spaces turned into car-sharing stations are allowed short-term use of the vehicles of the stations they manage during periods when the vehicle concerned is not reserved. This helps to ensure effective utilization of idle parking spaces. In order to smoothly implement the aforesaid features, the vehicle rental management apparatus of the present embodiment is configured as described in the following.

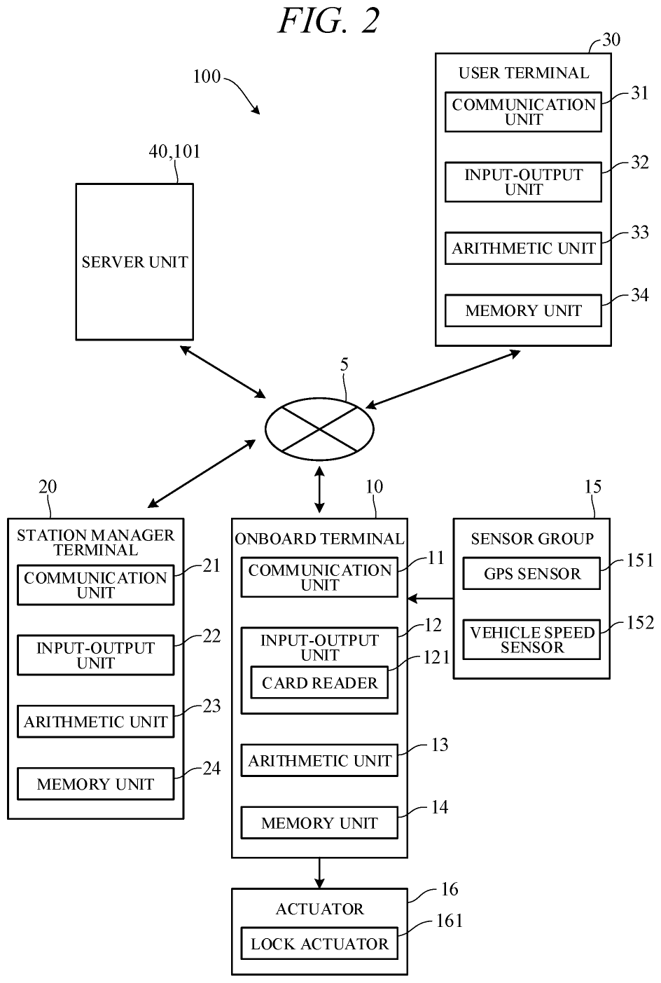

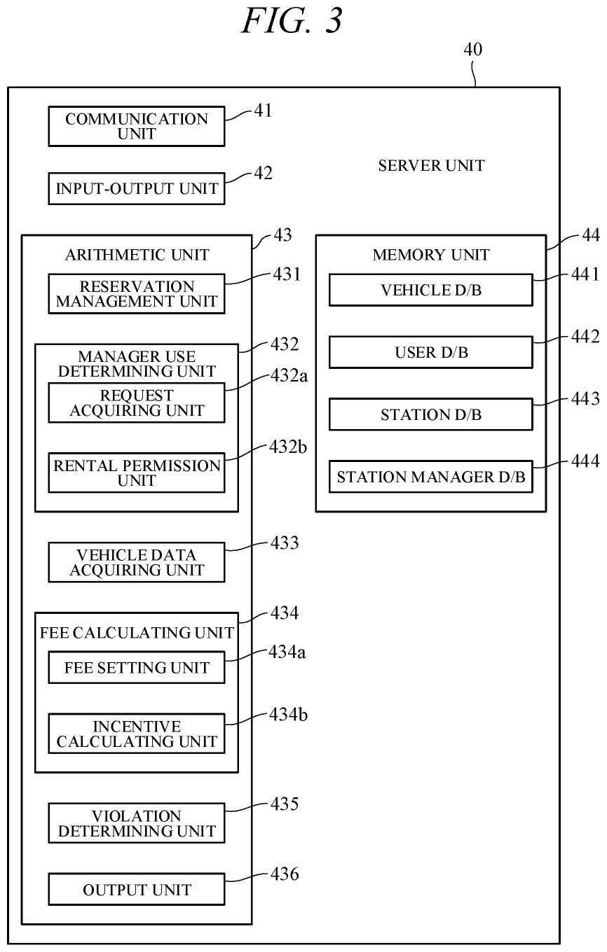

FIG. 2 is a block diagram showing overall configuration of the vehicle rental management system 100 incorporating the vehicle rental management apparatus 101 according to the embodiment of the present invention. FIG. 3 is a block diagram showing main configuration of the server unit 40 of FIG. 2. As shown in FIG. 2, the vehicle rental management system 100 comprises onboard terminals 10, station manager terminals 20, user terminals 30, and a server unit 40, as in FIG. 1. The vehicle rental management apparatus 101 according to the present embodiment is configured chiefly by the server unit 40.

The onboard terminals 10, station manager terminals 20, user terminals 30 and server unit 40 are connected to a communication network 5 such as a wireless communications network, Internet network or telephone network. Although for convenience of illustration FIG. 2 shows only one each of the onboard terminals 10, station manager terminals 20 and user terminals 30, the vehicle rental management system 100 can be configured to include onboard terminals 10 of multiple vehicles 1, station manager terminals 20 of multiple station managers, and user terminals 30 of multiple users, as shown in FIG. 1, for example. While only a single server unit 40 is shown in FIG. 2 and FIG. 3, functions indicated in the server unit 40 of FIG. 2 and FIG. 3 can be divided among multiple server units. At least a part of communication routes can use wire communication rather than wireless communication.

The onboard terminal 10 can be configured to comprise an onboard navigation unit, for example. The onboard terminal 10 includes a communication unit 11, input-output unit 12, arithmetic unit 13 and memory unit 14. A sensor group 15 and actuators 16 are connected to the onboard terminal 10.

The sensor group 15 includes various sensors for detecting vehicle condition. By way of example, the sensor group 15 comprises a GPS sensor 151 for detecting position of the vehicle 1 using signals from GPS satellites, and a vehicle speed sensor 152 for detecting vehicle speed. Although not shown in the drawings, the sensor group 15 also comprises other sensors including, for example, an acceleration sensor for detecting acceleration acting on the vehicle 1, a gyro sensor for detecting angular velocity, an odometer sensor for measuring distance traveled, a fuel level sensor for detecting remaining fuel amount, a battery charge sensor for detecting remaining battery charge, and a door open/close sensor for detecting opening and closing of a luggage compartment door.

The actuators 16 are adapted to drive various equipment (mechanisms and devices) installed in the vehicle 1 in response to instructions from the onboard terminal 10 (arithmetic unit 13). To cite a specific example, the actuators 16 include a lock actuator 161 for unlocking and locking a door lock. The lock actuator 161 unlocks or locks an associated door lock in response to an unlock signal or lock signal from the arithmetic unit 13. In addition, other actuators, for example an engine actuator, transmission actuator, braking apparatus actuator and steering actuator, are also included among the actuators 16.

The communication unit 11 is configured to communicate with the server unit 40 wirelessly via the communication network 5. The communication unit 11 sends a vehicle ID for identifying the vehicle 1, along with some of the signals received from the sensor group 15, to the server unit 40 at predetermined time intervals.

The input-output unit 12 is equipped with various user operable switches, buttons, microphone, speaker, monitor and the like. Moreover, the input-output unit 12 has a card reader 121 for reading user data from an authentication card carried by the user. As the authentication card is used, for example, a driver's license (IC card license) that stores user personal data written into an integrated circuit (IC) chip. The card reader 121 is installed at a predetermined part of the vehicle 1 (e.g., bottom of rear window) to be capable of recognizing the authentication card when brought near the vehicle from outside.

The arithmetic unit 13, which has a CPU, performs predetermined processing based on signals received through the input-output unit 12, signals detected by the sensor group 15, signals received via the communication unit 11 from outside the onboard terminal 10 and data stored in the memory unit 14, and outputs control signals to the actuators 16 of the vehicle 1, the input-output unit 12 and the memory unit 14.

In addition, the arithmetic unit 13 outputs control signals to the communication unit 11 so as to control exchange of signals between the onboard terminal 10 and the server unit 40. For example, when the user brings his or her authentication card near the card reader 121 when starting to use the vehicle, the arithmetic unit 13 transmits user data read through the card reader 121 through the communication unit 11 to the server unit 40. The server unit 40 determines presence/absence of reservation data corresponding to the received user data. When the server unit 40 determines that corresponding reservation data are present, its sends an unlock instruction to the arithmetic unit 13, and when it finds no corresponding reservation data, it sends a lock instruction. The arithmetic unit 13 sends the lock actuator 161 an unlock signal upon receiving an unlock instruction and sends it a lock signal upon receiving a lock instruction.

The memory unit 14 includes volatile memory or nonvolatile memory not indicated in the drawings. Various programs executed by the arithmetic unit 13 and various data are stored in the memory unit 14. For example, the memory unit 14 temporarily stores data detected by the sensor group 15. The stored detection data are, in accordance with processing performed by the arithmetic unit 13, transmitted through the communication unit 11 to the server unit 40 at predetermined time intervals.

The station manager terminal 20 is configured by means of, for example, a mobile wireless terminal, typically a personal computer or smart phone, operated by the station manager. The station manager terminal 20 comprises a communication unit 21, an input-output unit 22, an arithmetic unit 23 and a memory unit 24.

The communication unit 21 is configured to communicate with the server unit 40 wirelessly via the communication network 5. The communication unit 21 transmits to the server unit 40 a station manager ID for identifying the station manager and a signal designating any manager request to use the vehicle 1 parked in the station 2 managed by the station manager. Moreover, when the station manager applies for or cancels reservation of the vehicle 1, in a manner similar to customer users, the communication unit 21 transmits to the server unit 40 the station manager ID and a signal instructing application for or cancellation of reservation of the vehicle 1.

In addition, the communication unit 21 receives from the server unit 40 in response to the station manager's use request data indicating whether the requested use of the vehicle 1 is possible. Further, the communication unit 21 receives from the server unit 40 data regarding time-based incentives for the station manager's use of the vehicle 1 parked in the station 2 he or she manages, e.g., data regarding incentive offered the station manager for using the vehicle 1 certain numbers of hours per month.

The input-output unit 22 has, for example, a keyboard, mouse, monitor, touch panel and so on. The station managers use their input-output units 22 to input vehicle 1 use requests, reservation requests, reservation cancellations, and the like. Information regarding the station managers (station manager data) is recorded in advance at the business entity running the car-sharing business. The station manager data include station manager address, name, contact information, driver's license number, data required for payment (settlement, e.g., credit card number), and so on. After inputting such station manager data and completing station manager registration, the station manager can run his or her idle parking space as a station 2 of the vehicle 1.

When a station manager requests use of the vehicle 1 parked in the manager's station 2, the server unit 40 conducts a search regarding reservation of the vehicle 1, and if one or more time periods during which the vehicle 1 is unreserved are found, the server unit 40 transmits data indicating the station manager tentative permission to use the vehicle 1 during the time periods concerned. The data indicating this use permission include the permitted time periods of vehicle 1 use and these time periods are displayed on the input-output unit 22. Use permission is finalized (firm) when the station manager selects a desired time period from among displayed time periods or when the station manager accepts a displayed time period.

The station manager can also make a vehicle 1 use request by using the input-output unit 22 to input desired date and time of vehicle 1 use. In this case, the server unit 40 responds to the desired date and time of vehicle 1 use input by the station manager by conducting a search as to whether reservation at the date and time is possible and transmits reservation availability data to the station manager terminal 20. These reservation availability data are displayed on the input-output unit 22. When the displayed data indicate that reservation is possible at the desired date and time, the station manager can complete the vehicle reservation by accepting the displayed reservation date and time.

When a vehicle reservation is requested, estimated vehicle 1 use fees are displayed on the input-output unit 22 as vehicle data. The displayed fees include fee per certain time period or per certain distance (base fee) and total use fee. Total use fee is calculated by multiplying the base fee by use time or use distance. The fee displayed at time of reservation request is an estimated fee, and the final use fee is determined using actual use time and travel distance of the vehicle 1 at return of the vehicle 1. The station manager is informed of the final use fee by displaying it on the input-output unit 22. The use fee (e.g., per-unit time fee) when the station manager uses the vehicle 1 is set lower than the use fee when the vehicle 1 is used by an ordinary customer user.

The arithmetic unit 23, which has a CPU, performs predetermined processing based on signals received through the input-output unit 22, signals received via the communication unit 21 from outside the station manager terminal 20 and data stored in the memory unit 24, and outputs control signals to the communication unit 21, the input-output unit 22 and the memory unit 24. By means of processing performed by the arithmetic unit 23, the station manager can confirm permission to user the vehicle 1 and change or confirm vehicle reservation using the input-output unit 22, for example, a monitor.

The memory unit 24 includes volatile memory or nonvolatile memory not indicated in the drawings. Various programs executed by the arithmetic unit 23 and various data are stored in the memory unit 24.

The user terminal 30 is configured by means of, for example, a mobile wireless terminal, typically a personal computer or smart phone, operated by the user. The user terminal 30 comprises a communication unit 31, an input-output unit 32, an arithmetic unit 33 and a memory unit 34.

The communication unit 31 is adapted to communicate with the server unit 40 wirelessly via the communication network 5. The communication unit 31 transmits to the server unit 40 user-identifying IDs as well as signals instructing reservation, reservation cancellation and the like of vehicles 1.

The input-output unit 32 has, for example, a keyboard, mouse, monitor, touch panel and so on. The user inputs user data through the input-output unit 32. User data include user address, name, contact information, driver's license number, data required for payment (settlement, e.g., credit card number), and so on. After inputting such user data and completing member registration, the user can use shared vehicles.

When applying for a vehicle reservation, vehicle reservation data is input by the user. For example, the user designates type of vehicle 1 to be used, area of pick-up and return locations (area of station 2 to be used), and date/time of using vehicle 1 (use start date/time and use end date/time). In response, the server unit 40 retrieves reservable vehicles 1 satisfying some or all of type, station and use date/time conditions of designated vehicle 1 and transmits data of one or multiple retrieved vehicle 1 candidates and station 2 candidates to the user terminal 30.

These vehicle data and station data are displayed on the input-output unit 32. Vehicle reservation is completed (firm) when the user uses the input-output unit 32 to select a desired vehicle 1 and a desired station 2 from among displayed vehicles 1 and stations 2 or when the user accepts a displayed vehicle 1 and a station 2.

When the vehicle 1 reservation is requested, estimated vehicle 1 use fees are displayed on the input-output unit 32 as vehicle data. The displayed fees include fee per certain time period or per certain distance (base fee) and total use fee. Total use fee is calculated by multiplying the base fee by use time or use distance. The fee displayed at time of reservation request is an estimated fee, and the final use fee is determined using actual use time and travel distance of the vehicle 1 at return of the vehicle 1. The user is informed of the final use fee by displaying it on the input-output unit 32.

The arithmetic unit 33, which has a CPU, performs predetermined processing based on signals received through the input-output unit 32, signals received via the communication unit 31 from outside the user terminal 30 and data stored in the memory unit 34, and outputs control signals to the communication unit 31, the input-output unit 32 and the memory unit 34. By means of processing performed by the arithmetic unit 33, the user can confirm permission to user the vehicle 1 and change or confirm vehicle reservation using the input-output unit 32, for example, a monitor.

The memory unit 34 includes volatile memory or nonvolatile memory not indicated in the drawings. Various programs executed by the arithmetic unit 33 and various data are stored in the memory unit 34.

The server unit 40 is installed on, for example, business entity running the car-sharing business. The server unit 40 is installed at a business engaged in car-sharing service. Optionally, the server unit 40 can be configured utilizing cloud virtual server functions. As shown in FIG. 3, the server unit 40 includes a communication unit 41, an input-output unit 42, an arithmetic unit 43 and a memory unit 44.

The communication unit 41 is adapted to communicate with the delivery terminal 10, station manager terminals 20 and user terminal 30 wirelessly via the communication network 5. The input-output unit 42 has, for example, a keyboard, mouse, monitor, touch panel and so on. The arithmetic unit 43, which has a CPU, performs predetermined processing based on signals input through the input-output unit 42, signals received through the communication unit 41 from outside the server unit 40 and data stored in the memory unit 44, and outputs control signals to the input-output unit 42 and the memory unit 44. Functional constituents of the arithmetic unit 43 are described later.

The memory unit 44 includes volatile memory or nonvolatile memory not indicated in the drawings. Various programs executed by the arithmetic unit 43 and various data are stored in the memory unit 44. As functional constituents supporting memory function, the memory unit 44 comprises a vehicle database (vehicle D/B) 441, a user database (user D/B) 442, a station database (station D/B) 443 and a station manager database (station manager D/B) 444.

The vehicle database 441 stores vehicle data regarding each of multiple vehicles 1 offered for car-sharing service, namely, each vehicle's type, year, VIN (body number), license plate number, mileage, maintenance history, utilization rate and other vehicle data indicative of vehicle condition and vehicle properties, and also stores use schedule data of each vehicle 1. The use schedule data include time-series use performance data, current and future time-series reservation data, and data regarding schedule of maintenance performed between reservations of each vehicle 1.

The user database 442 stores user data of individual users including user ID, address, name, contact information, driver's license number and other information input through the user terminals 30 (input-output unit 32), and data indicating user reliability (reliability data) including vehicle 1 use history, payment status of use fee, accident history, traffic violation history and other information of each user. Namely, the user database 442 stores user data and reliability data of individual users in association with user ID of individual users. Reliability rating decreases with each accident or traffic violation and is higher in proportion as degree (severity) of accident or traffic violation is lower.

The station database 443 stores station data regarding each of multiple station 2 offered for car-sharing service, namely, stores address of each station 2, ID and name of station manager managing each station 2, and the vehicle data of each vehicle 1 parked at each station 2.

The station manager database 444 stores station manager data including station manager ID, address, name, contact information, driver's license number and other information of individual station managers input through the station manager terminals 20 (input-output unit 22), use fee data including information of the base fee for use of the vehicle 1 permitted, and station manager reliability data indicating reliability of each station manager including vehicle 1 use history, payment status of use fee, accident history, and traffic violation history. Namely, the station manager database 444 stores station manager data, fee data, and reliability data of individual station managers in association with station manager ID of individual station managers.

As functional constituents supporting processor function, the arithmetic unit 43 comprises a reservation management unit 431, a manager use determining unit 432, a vehicle data acquiring unit 433, a fee calculating unit 434, a violation determining unit 435 and an output unit 436.

The reservation management unit 431 receives vehicle 1 use requests input by users via the user terminals 30 (input-output units 32). The reservation management unit 431 communicates with the communication unit 41 to receive reservable vehicle 1 data matching vehicle reservation data input by a user, including, for example, desired type of vehicle 1, desired vehicle 1 pick-up location (station 2 area), and desired vehicle 1 use date and time. In addition, the reservation management unit 431 conducts a search of the vehicle database 441 to find a reservable vehicle 1 meeting some or all of the designated type of vehicle 1, station 2 and use date and time.

At this time, the reservation management unit 431 accesses the user database 442 to extract reliability data of the user who requested vehicle reservation, and when the user's reliability is at least a predetermined value, stations 2 managed by station managers are included in the searchable range. In other words, when the reliability of a user who requested vehicle reservation is lower than the predetermined value, the server unit 40 excludes stations 2 managed by stations managers from the available vehicle pick-up locations. Since high user reliability is therefore set as a condition for permitting use of stations 2 managed by station managers as vehicle 1 pick-up locations, station managers can be relieved of anxiety about use of their parking spaces by car-share service users. The reservation management unit 431 transmits the data retrieved regarding vehicles 1 and stations 2 to the user terminal 30 concerned and accepts the vehicle use reservation request for the vehicle 1 selected or accepted by the user as the reserved vehicle.

The reservation management unit 431 creates current and future use plans for every vehicle 1 and records the created use plans in the vehicle database 441. Specifically, in addition to the reserved vehicle use plans received via the user terminals 30 (input-output units 32), the reservation management unit 431 further creates use plans of station manager vehicle use determined by a rental permission unit 432b discussed later and records them in the vehicle database 441. Each use plan includes date and time of start and end of reserved vehicle use, date and time of station manager vehicle use, and periodic maintenance plan.

The manager use determining unit 432 determines based on the individual use plans created by the reservation management unit 431 whether use of vehicle 1 by the station manager concerned is possible. Specifically, when a vehicle reservable time period not included in the created use plan is available, the manager use determining unit 432 makes a determination giving permission of vehicle 1 use by the station manager during the time period concerned. The manager use determining unit 432 determines whether use under terms of the vehicle 1 use request input by the station manager via the station manager terminal 20 is possible. As functional constituents, the manager use determining unit 432 has a request acquiring unit 432a and a rental permission unit 432b.

The request acquiring unit 432a receives vehicle 1 use requests input by station managers through their station manager terminals 20 (input-output units 22). The request acquiring unit 432a acquires data regarding use requests from station managers through the communication unit 41, for example.

When the request acquiring unit 432a acquires data regarding a use request, the rental permission unit 432b searches the use plan created by the reservation management unit 431 for vehicle reservable time periods not included in the reserved vehicle use dates and times, and when a retrieved time period is within a first predetermined time period Δta (e.g., 1 hour) and not shorter than a second predetermined time period Δtb (e.g., 30 minutes), the rental permission unit 432b permits use of the vehicle 1 for the second predetermined time period Δtb within said time period. This is based on the reasoning that if a vehicle unreserved time period is 1 hour, for instance, the station manager can be allowed to use the vehicle 1 for a certain period within 1 hour (e.g., for 30 minutes). The station manager is thus able to use the vehicle 1 for short periods within periods when the vehicle 1 is not reserved. So even without owning a car, the station manager has access to one (the vehicle 1) to use for, for example, local shopping or transporting family or friends to or from a local station, and can therefore effectively utilize the vehicle 1, even if only occasionally.

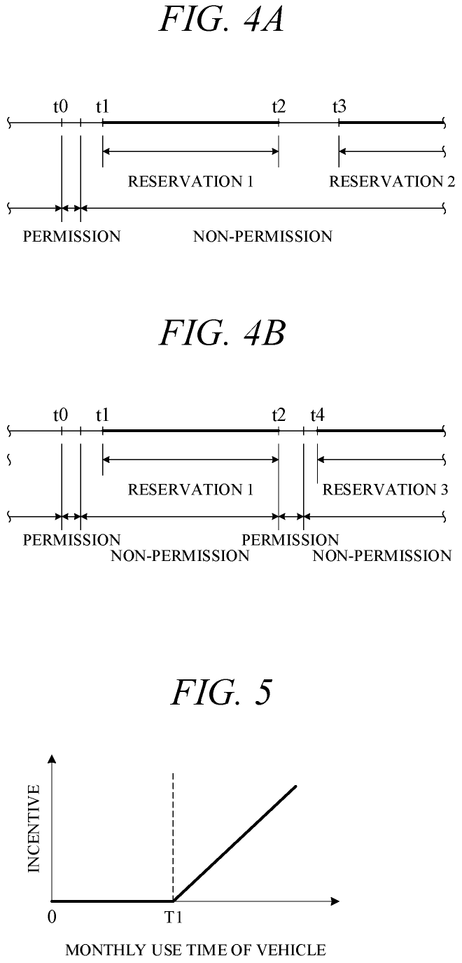

FIGS. 4A and 4B are diagrams each showing an example of vehicle reservation data. The rental permission unit 432b uses such vehicle reservation data to determine whether vehicle use by a station manager is possible. In the example of FIG. 4A, the request acquiring unit 432a acquires a use request from the station manager at time t0. At time t10, the use plan already includes vehicle reserved time periods between time t1 and t2 (reservation 1) and from time t3 onward (reservation 2). On the other hand, the time periods between time t0 and time t1 and between time t2 and time t3 are vehicle reservable time periods not included in the use plan. Of these time periods, time period t0 to t1 is within first predetermined time period Δta (1 hour). So a reservation falling in the period between time t0 and time t1 is unlikely to be received from a user later than this time. On the other hand, time period t2 to t3 is longer than first predetermined time period Δta, so a reservation falling within the period between time t2 and time t3 being received from a user from now on is not unlikely. The rental permission unit 432b therefore responds to the vehicle 1 use request from the station manager by transmitting through the communication unit 41 to the station manager terminal 20 concerned data indicating vehicle 1 use permission during second predetermined time period Δtb within time t0 to time t1 (more exactly, data indicating vehicle 1 use permission for 30 min starting from time t0). When the station manager accepts, the rental permission unit 432b makes a determination finalizing permission to use the vehicle 1 for 30 minutes starting from time t0.

In the example of FIG. 4B, users have made vehicle use reservation between time t0 and time t1 (reservation 1) and from time t4 onward (reservation 3), and should the time period between time t2 and time t4 be within the first predetermined time period Δta, a reservation falling in this period between time t2 and time t4 is unlikely to be received from a user from now on. In this case, the rental permission unit 432b responds to the vehicle 1 use request from the station manager by transmitting to the station manager terminal 20 concerned data indicating use permission for 30 minutes starting from time t0 and for 30 minutes starting from time t2. And the rental permission unit 432b permits use of the vehicle 1 for the time period selected by the station manager. After determining permission of the vehicle 1 by the station manager, the rental permission unit 432b transmits data indicating time period of the determined use permission to the reservation management unit 431. Upon receiving the time period data from the rental permission unit 432b, the reservation management unit performs processing to add the time period concerned to the use plan.

Thus in the present embodiment a vehicle reservable time period not included in the use plan means a vehicle reservable time period that is not included in the use plan at the time the request acquiring unit 432a received the data related to the use request, that falls within first predetermined time period Δta unlikely to be subject to reservation, and that is at least as long as second predetermined time period Δtb. Optionally, difference between first predetermined time period Δta and second predetermined time period Δtb can be set shorter than 30 minutes. For example, second predetermined time period Δtb can be set to the same length as the first predetermined time period Δta (1 hour). This makes it possible to set the time period that the vehicle 1 is usable by the station manager to a time period shorter than second predetermined time period Δtb by a certain time period.

The vehicle data acquiring unit 433 accesses the vehicle database 441 to acquire vehicle data including use history of the individual vehicles 1 rentable to users. The acquired vehicle data include use time and use distance of the individual vehicles 1 per predetermined period (e.g., 1 month).

The fee calculating unit 434 calculates vehicle 1 use fee and incentive to be offered a station manager when predetermined conditions are met. As functional constituents, the fee calculating unit 434 has a fee setting unit 434a and an incentive calculating unit 434b.

The fee setting unit 434a sets a use fee when a station manager permitted to use a vehicle 1 uses the vehicle 1. The fee setting unit 434a sets use fees so as to establish a difference between use fee per unit time when a station manager uses a vehicle 1 and use fee per unit time when a customer user uses the vehicle 1. Typically, the fee setting unit 434a sets use fees so that use fee per unit time in case of a station manager using a vehicle 1 is lower than use fee per unit time in case of a user using the vehicle 1. Optionally, the fee setting unit 434a can make charge per unit time free in case of a station manager using a vehicle 1. The set use fee is stored in the station manager database 444.

Based on use fees per unit time (base fees) set by the fee setting unit 434a, the fee calculating unit 434 calculates a use fee for a user by multiplying the base fee by time used or distance used and calculates use fee for a station manager by multiplying the base fee by time used.

When use time of a vehicle 1 by users within a predetermined time period (e.g., 1 month) is equal to or longer than a predetermined time period, the incentive calculating unit 434b calculates, based on period of use of the vehicle 1 by users, an incentive to be offered the station manager (e.g., remuneration to be paid to the station manager). For example, when monthly use time of the vehicle 1 in the station 2 managed by the station manager is equal to or greater than T1 hours, opportunities for the station manager to use the vehicle 1 decrease markedly. As benefit to the station manager therefore evaporates, no motivation remains to offer the idle parking space as a station 2. Taking this point into consideration, the incentive calculating unit 434b is adapted to calculate an incentive to be paid the station manager in accordance with use time of the vehicle 1 in cases of use time of the vehicle 1 by users within a certain time period being predetermined time period T1 or greater. The business entity running the vehicle rental service can suitably define the predetermined time period T1 as zero or greater. For example, in an area where competition with other service providers is intense, or during a campaign or the like to recruit station managers, the predetermined time period T1 can be set shorter than usual.

FIG. 5 is a diagram showing a concrete example of relation between incentive (remuneration) calculated by the incentive calculating unit 434b and vehicle 1 monthly use time. For example, as indicated in FIG. 5, the incentive calculating unit 434b calculates amount of remuneration (incentive) so as to increase in proportion to degree by which vehicle 1 monthly use time by customer users exceeds predetermined time period T1.

The violation determining unit 435 uses signals acquired by the sensor group 15 of the onboard terminal 10 to determine whether the user of the vehicle 1 violated a traffic regulation. For example, the violation determining unit 435 determines current position of the vehicle 1 based on a signal from the GPS sensor 151 and determines whether the user is violating speed limit by comparing vehicle 1 speed limit at current position of the vehicle 1 and vehicle speed indicated by a signal from the vehicle speed sensor 152. Optionally, parking violation can be determined by using signals from the GPS sensor 151 to determine whether the vehicle 1 is parked at a place where parking is prohibited. When a traffic violation is determined, user's reliability data are updated by lowering the user's reliability rating stored in the user database 442.

The output unit 436 outputs data regarding use permission of the vehicle 1 for the predetermined time period from the rental permission unit 432b to the reservation management unit 431, and outputs the same data to the station manager terminal 20 through the communication unit 41. The station manager is thus able to confirm use permission for the vehicle 1 use.

The output unit 436 also outputs use fee data for the user calculated by the fee calculating unit 434 to the vehicle database 441 and the user database 442 to be stored, and outputs the same data to the user terminal 30 through the communication unit 41. The user is thus able to confirm use fee for the vehicle 1 use. The output unit 436 also outputs use fee data for the station manager calculated by the fee calculating unit 434 and incentive data for the station manager calculated by the incentive calculating unit 434b to the vehicle database 441 and the station manager database 444 to be stored, and outputs the same data to the station manager terminal 20 through the communication unit 41. The station manager is thus able to confirm use fee and incentive for the vehicle 1 use.

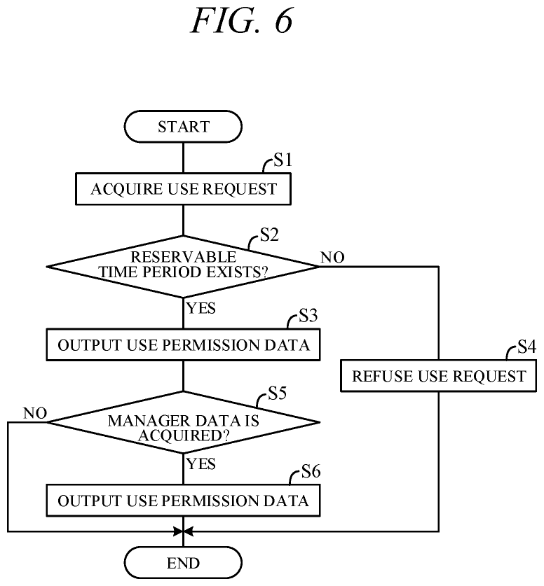

FIG. 6 is a flowchart showing an example of processing performed by the arithmetic unit 43 in accordance with a program stored in the memory 44 of the server unit 40 in advance, specifically an example of processing related to use application for the vehicle 1 by the station manager. The processing indicated in this flowchart is started, for example, when the server unit 40 receives signals instructing use application for the vehicle 1 from the station manager terminal 20, and is repeatedly performed periodically at predetermined intervals.

First, in S1 (S: processing Step), the request acquiring unit 432a performs processing for acquiring vehicle 1 use requests transmitted from the station manager terminals 20 and also for acquiring data regarding registered vehicle 1 use plans created by the reservation management unit 431. Next, in S2, the rental permission unit 432b performs processing in response to each use request to determine whether a predetermined time period starting from current time (e.g., 24 hours or 48 hours) includes a vehicle reservable time period of a length falling within a predetermined range and not included in the user vehicle reservation data, namely, whether a reservable time period falling within the first predetermined time period Δta and equal to or greater than the second predetermined time period Δtb is available. When the result in S2 is NO, the program goes to S4, in which the rental permission unit 432b performs processing to refuse the vehicle 1 use request, whereafter processing is terminated.

When the result in S2 is YES, the program goes to S3, in which vehicle 1 use permission data are transmitted to the station manager terminal 20 concerned and vehicle 1 use possible data are output to the input-output unit 22 of the station manager terminal 20. When two or more vehicle reservable time ranges not included in the customer user vehicle reservation data are available, all of the available time ranges are output.

Next, in S5, whether the station manager transmitted an acceptance of the use possible data or a selection of the use time period data (manager data) is determined. When the result in S5 is NO, processing is terminated. When the result in S5 is YES, the program goes to S6. In S6, the rental permission unit 432b performs processing for finalizing permission of vehicle 1 use by the station manager and for transmitting use permission data together with use fee data through the communication unit 41 to the station manager terminal 20, whereafter processing is terminated.

The present embodiment can achieve advantages and effects such as the following:

(1) The vehicle rental management apparatus 101 incorporates idle parking spaces as stations 2 of vehicles 1 used in vehicle rental service and manages rental of the vehicles 1. The vehicle rental management apparatus 101 comprises the reservation management unit 431 for managing vehicle use plans and the manager use determining unit 432 for determining on an individual station manager basis whether use of the vehicle 1 by the station manager in charge of the station 2 is possible (FIG. 3). When a vehicle reservable time period of predetermined length not included in the vehicle use plan concerned managed by the reservation management unit 431 (time period falling within the first predetermined time period Δta and equal to or greater than the second predetermined time period Δtb) is available, the manager use determining unit 432 permits use of the vehicle 1 by the station manager within said time period (within second predetermined time period Δtb).

Owing to this configuration, individual station managers are able to use the vehicles 1 in their stations 2 for a predetermined time period (e.g., 30 minutes) when a vehicle reservable time period of predetermined length (e.g., 1 hour) not included in the vehicle 1 use plan concerned is available. Thus, even without owning a car, the station manager has access to one (the vehicle 1) to use for short periods during periods the vehicle is not reserved and can therefore effectively utilize the vehicle 1, even if only occasionally, for errands such as local shopping and transporting family or friends to and from a local station. Moreover, the fact that the car-sharing service vehicle 1 pick-up locations are residential parking spaces makes the car-sharing service more convenient that conventional ones because time required for a user to reach a vehicle 1 is shorter than usual. In addition, the fact that the vehicle 1 is owned by a business entity specialized in the car-sharing business means that the vehicle 1 is periodically inspected, maintained and cleaned under supervision of the business entity, and also means that the station manager is not required to pay taxes or the like with respect to the vehicle 1.

(2) When a vehicle 1 use request is received from an station manager and a reservable period not longer than first predetermined time period Δta (e.g., 1 hour) is available, the manager use determining unit 432 permits use of the vehicle 1 for second predetermined time period Δtb (e.g., 30 minutes) shorter than first predetermined time period Δta. As use permission is therefore determined in accordance time period desired by the station manager, the vehicle 1 use plan can be efficiently created.

(3) The vehicle rental management apparatus 101 further comprises the fee calculating unit 434 for calculating use fees arising in connection with rental of the vehicles 1 (FIG. 3). The fee calculating unit 434 calculates use fees of the vehicles 1 so as to establish a difference between use fee per unit time for customer users using the vehicles 1 and use fee per unit time for station managers using the vehicles 1. As a result, charge per unit time can be made free or set low in case of a station manager using a vehicle 1. This in turn increases the benefit station managers enjoy by providing their idle residential parking spaces as stations for car-sharing service vehicles 1.

(4) The fee calculating unit 434 calculates use fees of the vehicle 1 so that use fee per unit time in case of a station manager is lower than use fee per unit time in case of a customer user. This makes use of the car-sharing service vehicles 1 economically advantageous for station managers.

(5) When vehicle use time by customer users within a predetermined time period is equal to or longer than the predetermined time period T1, the fee calculating unit 434 sets, based on period of use of the vehicle 1 by users, an incentive to be offered the station manager concerned (FIG. 5). The station manager is therefore paid an incentive in a case where the station manager seldom has an opportunity to use the vehicle 1 parked in the station 2 he or she manages owing to the vehicle 1 having come to be frequently reserved

as a result of, for example, the station 2 managed by the station manager having become highly popular due to its exceptional convenience. The station manager can therefore be positively motivated to continue to offer his or her idle parking space for use as the station 2.

(6) When period of use of the vehicle 1 by users within the predetermined time period exceeds the predetermined time period T1, the fee calculating unit 434 calculates the incentive as remuneration that increases in proportion to the length of use time beyond the predetermined time period T1. The station manager can therefore be expected to be more highly motivated to continue to positively offer his or her idle parking space for use as the station 2.

In the aforesaid embodiment, the manager use determining unit 432 is adapted to respond to availability of a vehicle reservable first predetermined time period Δta not included in the vehicle reservation data managed by the reservation management unit 431 by permitting use of the vehicle 1 by the station manager within a second predetermined time period Δtb shorter than the first predetermined time period Δta. More specifically, the manager use determining unit 432 is adapted to permit use of the vehicle 1 by the station manager during the second predetermined time period Δtb reckoned from starting point of the first predetermined time period Δta (t0 of FIG. 4A; t0/t2 of FIG. 4B). However, the manager use determining unit can be of any configuration insofar as it responds to availability of a vehicle reservable time period of predetermined length not included in the vehicle reservation data managed by the reservation management unit 431 by permitting use of the vehicle 1 by the station manager during such time period. Optionally, for example, setting of the second predetermined time period Δtb can be omitted and the station manager permitted to use the vehicle 1 during the first predetermined time period Δta. Optionally, a configuration can be adopted that sets the first predetermined time period Δta in accordance with length of remaining time period from current time point (time point earlier than t0/t2) to time point when permission to use of vehicle 1 becomes possible (t0/t2). For example, since probability of a reservation being received from a user decreases as remaining period is shorter, the first predetermined time period Δta can be set longer. Optionally in this case, the second predetermined time period Δtb can be changed in accordance with length of the first predetermined time period Δta. Namely, the second predetermined time period Δtb can be lengthened as the first predetermined time period Δta grows longer.

In the aforesaid embodiment, the vehicle rental management system 100 is configured by the onboard terminals 10, the station manager terminals 20, the user terminals 30 and the server unit 40, and the server unit 40 comprises the reservation management unit 431, the manager use determining unit 432, the vehicle data acquiring unit 433, the fee calculating unit 434 and the violation determining unit 435 to perform a main function of the vehicle rental management system 100. However, it is optionally possible to some or all of these functions are provided by an equipment other than the server unit, for example, a business entity terminal.

In the aforesaid embodiment, the server unit 40 is configured by the reservation management unit 431, the manager use determining unit 432, the vehicle data acquiring unit 433, the fee calculating unit 434 and the violation determining unit 435. However, as long as the server unit 40 comprises management unit 431 and the manager use determining unit 432, the vehicle data acquiring unit 433, the fee calculating unit 434 and the violation determining unit 435 can be omitted.

In the aforesaid embodiment, the vehicle rental management apparatus is applied to entity engaged in the car-sharing business, for example, a dealer or the like engaged in sell or maintenance or the like of car. However, the vehicle rental management apparatus according to the present invention can be similarly applied to other entities such as an entity engaged in a rental car business.

The present invention can be also used as a vehicle rental management method to incorporate idle parking spaces as the stations 2 of the vehicles 1 used in vehicle rental service to manage rental of the vehicle.

The above embodiment can be combined as desired with one or more of the above modifications. The modifications can also be combined with one another.

According to the present invention, it is possible to achieve effective use of idle parking spaces and to enhance convenience of vehicle rental service.

Above, while the present invention has been described with reference to the preferred embodiments thereof, it will be understood, by those skilled in the art, that various changes and modifications may be made thereto without departing from the scope of the appended claims.

What is claimed is:

1. A vehicle rental management apparatus configured to incorporate an unused parking space as a station of a vehicle used in a vehicle rental service to manage rental of the vehicle, the vehicle rental management apparatus comprising:
an electronic control unit having a microprocessor and a memory connected to the microprocessor, wherein
the microprocessor is configured to perform:
managing a reservation data of a user of the vehicle; and
determining whether use of the vehicle by a station manager managing the station is possible, wherein
the determining includes permitting use of the vehicle by the station manager within a reservable time period during which the vehicle is not reserved by the user when the reservable time period of a predetermined length is found from the vehicle reservation data managed in the managing.

2. The vehicle rental management apparatus according to claim 1, wherein
the microprocessor is further configured to perform
the determining including permitting the use of the vehicle by the station manager within the reservable time period when a request to use the vehicle is received from the station manager and the reservable time period of the predetermined length is found from the vehicle reservation data managed in the managing.

3. The vehicle rental management apparatus according to claim 1, wherein
the microprocessor is further configured to perform
calculating a rental fee for the vehicle, wherein
the calculating includes calculating the rental fee of the vehicle so that a base fee per unit time for the user and a base fee per unit time for the station manager differ from each other.

4. The vehicle rental management apparatus according to claim 3, wherein
the microprocessor is further configured to perform
the calculating including calculating the rental fee of the vehicle so that the base fee per unit time for the station manager is lower than the base fee per unit time for the user.

5. The vehicle rental management apparatus according to claim 3, wherein
the microprocessor is further configured to perform
the calculating further including calculate an amount of an incentive offered to the station manager based on a use time period of the vehicle by the user when the use time period of the vehicle by the user within the reservable time period is equal to or longer than a predetermined time period.

6. The vehicle rental management apparatus according to claim 5, wherein
the microprocessor is further configured to perform
the calculating including calculating the amount of the incentive so that the amount of the incentive increases in proportion to a length of an exceeding time period of the use time period beyond the predetermined time period.

7. The vehicle rental management apparatus according to claim 6, wherein
the incentive is a remuneration to be paid to the station manager.

8. The vehicle rental management apparatus according to claim 1, wherein
the predetermined length is a first predetermined length, wherein
the microprocessor is further configured to perform
the determining including permitting use of the vehicle by the station manager within a time period of a second predetermined length shorter than the first predetermined length when the reservable time period of the first predetermined length is found from the vehicle reservation data managed in the managing.

9. The vehicle rental management apparatus according to claim 8, wherein
the microprocessor is further configured to perform
the determining including permitting use of the vehicle by the station manager within the time period of the second predetermined length from a start time of the reservable time period of the first predetermined length found.

10. A vehicle rental management apparatus configured to incorporate an unused parking space as a station of a vehicle used in a vehicle rental service to manage rental of the vehicle, the vehicle rental management apparatus comprising:
an electronic control unit having a microprocessor and a memory connected to the microprocessor, wherein
the microprocessor is configured to function as:
a reservation management unit configure to manage a reservation data of a user of the vehicle; and
a manager use determining unit configure to determine whether use of
the vehicle by a station manager managing the station is possible, wherein
the manager use determining unit is further configure to permit use of the vehicle by the station manager within a reservable time period during which the vehicle is not reserved by the user when the reservable time period of a predetermined length is found from the vehicle reservation data managed by the reservation management unit.

11. The vehicle rental management apparatus according to claim 10, wherein
the manager use determining unit is configure to permit the use of the vehicle by the station manager within the reservable time period when a request to use the vehicle is received from the station manager and the reservable time period of the predetermined length is found from the vehicle reservation data managed by the reservation management unit.

12. The vehicle rental management apparatus according to claim 10, wherein
the microprocessor is further configured to function as
a fee calculating unit configure to calculate a rental fee for the vehicle,
wherein
the fee calculating unit is configured to calculate the rental fee of the vehicle so that a base fee per unit time for the user and a base fee per unit time for the station manager differ from each other.

13. The vehicle rental management apparatus according to claim 12, wherein
the fee calculating unit is configured to calculate the rental fee of the vehicle so that the base fee per unit time for the station manager is lower than the base fee per unit time for the user.

14. The vehicle rental management apparatus according to claim 12, wherein
the fee calculating unit is further configured to calculate an amount of an incentive offered to the station manager based on a use time period of the vehicle by the user when the use time period of the vehicle by the user within the reservable time period is equal to or longer than a predetermined time period.

15. The vehicle rental management apparatus according to claim 14, wherein
the fee calculating unit is configured to calculate the amount of the incentive so that the amount of the incentive increases in proportion to a length of an exceeding time period of the use time period beyond the predetermined time period.

16. The vehicle rental management apparatus according to claim 15, wherein
the incentive is a remuneration to be paid to the station manager.

17. The vehicle rental management apparatus according to claim 10, wherein
the predetermined length is a first predetermined length, wherein
the manager use determining unit is configure to permit use of the vehicle by the station manager within a time period of a second predetermined length shorter than the first predetermined length when the reservable time period of the first predetermined length is found from the vehicle reservation data managed by the reservation management unit.

18. The vehicle rental management apparatus according to claim 17, wherein
the manager use determining unit is configure to permit use of the vehicle by the station manager within the time period of the second predetermined length from a start time of the reservable time period of the first predetermined length found.

19. A vehicle rental management method configured to incorporate an unused parking space as a station of a vehicle used in a vehicle rental service to manage rental of the vehicle, the vehicle rental management method comprising:
managing a reservation data of a user of the vehicle; and
determining whether use of the vehicle by a station manager managing the station is possible, wherein
the determining further includes permitting use of the vehicle by the station manager within a reservable time period during which the vehicle is not reserved by the user when the reservable time period of a predetermined length is found from the vehicle reservation data managed in the managing.
